(19) United States
(12) Patent Application Publication
(10) Pub. No.: US 2026/0360183 A1
(43) Pub. Date: Nov. 12, 2026

(54) MULTI-TASKING ACTION UNIT PREDICTIONS

(71) Applicants: Hewlett-Packard Development Company, L.P., Spring, TX (US); Purdue Research Foundation, West Lafayette, IN (US)

(72) Inventors: Shibo Zhang, Palo Alto, CA (US); Jishang Wei, Guilford, CT (US); Justin Yang, West Lafayette, IN (US); Prahalathan Sundaramoorthy, Palo Alto, CA (US); Xiaoyu Ji, West Lafayette, IN (US)

(21) Appl. No.: 19/120,085

(22) PCT Filed: Oct. 20, 2022
(86) PCT No.: PCT/US2022/047279

§ 371 Date: Apr. 10, 2025

(51) Int. Cl. G06V 40/16; G06T 11/60; G06V 10/14; G06V 10/764; G06V 10/766; G06V 10/774; G06V 10/82

(52) U.S. Cl. CPC G06V 40/176; G06T 11/60; G06V 10/14; G06V 10/764; G06V 10/766; G06V 10/774; G06V 10/82; G06V 40/166

(57) ABSTRACT

In an example in accordance with the present disclosure, a multi-tasking learning expression tracking system is described. The system includes a feature extractor to extract a feature representation from an image of a user. The system also includes a classification branch having a classification neural network and the feature extractor to, during training, predict expression classes for training images having different expressions. The system also includes a regression branch comprising a regression neural network and the feature extractor to, during training, predict action unit (AU) intensities for the training images and during deployment predict an AU intensity for the image of the user.

### BACKGROUND

An extended reality (XR) system provides a digital representation of an environment or presents virtual elements that are laid over an actual scene. A user can interact with the virtual elements in either the entirely digital scene or the mixed digital/real world scene. An example of such an XR system is a head-mounted display (HMD) that is worn by the user. XR systems can provide visual stimuli, auditory stimuli, and/or can track user movement to create a rich interactive experience.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a multi-tasking expression tracking system, according to an example of the principles described herein.

FIG. 2 is a diagram of an extended reality (XR) system which includes the multi-tasking expression tracking system, according to an example of the principles described herein.

FIG. 3 is a flowchart of a method for tracking facial expressions via a multi-tasking expression tracking system, according to an example of the principles described herein.

FIG. 4 is a flowchart of a method for tracking facial expressions via a multi-tasking expression tracking system, according to an example of the principles described herein.

FIG. 5 depicts the training of the multi-tasking expression tracking system, according to an example of the principles described herein.

FIG. 6 depicts a training stage of the multi-tasking expression tracking system, according to an example of the principles described herein.

FIG. 7 depicts a deployment stage of the multi-tasking expression tracking system, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Extended reality (XR) systems create an entirely digital environment or display a real-life environment augmented with digital components. In these environments, a user can interact with the XR environment. XR systems include virtual reality (VR) systems, augmented reality (AR) systems, and mixed reality (MR) systems. Such XR systems can include XR headsets that generate realistic images, sounds, and other human discernable sensations that simulate a user's physical presence in a virtual environment presented at the headset. A VR system presents virtual imagery representative of physical spaces and/or objects. AR systems provide a real-world view of a physical environment with virtual imagery/objects overlaid thereon. MR systems re-create a real world to a user with virtual imagery/objects overlaid thereon when the user does not have a direct view of the real world. For simplicity, VR systems, AR systems, and MR systems are referred to herein as extended reality systems.

Extended reality (XR) is emerging as a desirable computing platform for facilitating communication as XR may enhance collaboration; present information in a palatable, enjoyable, and effective manner; and introduce new immersive environments for entertainment, productivity, or other purpose. XR systems are found in many industries including healthcare, telecommunication, education, and training, among others. While XR systems undoubtedly have changed, and will continue to change, the way individuals communicate, some technological advancements may further increase their impact on society.

For example, in many XR systems, an avatar is generated to represent the user in the XR environment. The avatar is a graphical representation of a user and can be animated to reflect actions of the users they represent. For example, the avatar may communicate with other avatars representing other users in the XR environment. However, avatars may not accurately represent the user nor the message the user is intending to convey.

For example, facial expressions convey the emotional status of an individual to others. As such, facial expressions are a relevant non-verbal aspect of human communication. Thus, the capability to track the facial expression of the user in real time is desirable and valuable when attempting to capture and convey the user's emotional state to another. Accurately conveying the emotional state aides in realizing an immersive communication experience. However, the highly complex nature of human facial muscles and of analyzing human facial expressions has been an impediment to developing an accurate and effective facial expression tracking system.

Facial expressions may be defined by action units (AUs), which refer to the coordinated action of individual muscles or groups of muscles to generate a particular expression. Such expressions are classified in the Facial Action Coding System (FACS) which categorizes facial movements by their appearance on the face. Examples of AUs include upper lid raiser, lips toward each other, nose wrinkle, lip corner puller, and lip comer depressor among others. Put another way, an AU classifies the facial muscle movements that correspond to a displayed facial emotion/facial expression. As such, facial expressions may be decomposed into AUs which represent muscular activity that produces facial appearance changes. The “intensity” of the AU, or the degree of movement of the muscle or muscle groups, is indicative of a degree of the facial expression and/or emotion of the user.

However, modeling and predicting human facial expression AUs is complicated for a variety of reasons. First, the human facial AU system is highly non-linear and entangled. That is, one single AU may affect the appearance of multiple regions on a human face and the appearance of one region on a human face may be affected by multiple AUs. Accordingly, effectively modeling the relationship of AUs and corresponding facial regions is challenging.

Moreover, human faces vary with respect to geometry and facial features. For example, child faces are different than adult faces and different individuals have different face shapes. Moreover, facial features such as facial hair, wrinkles, skin imperfections, etc. may complicate accurate facial expression recognition. Still further, XR systems are used in a variety of lighting conditions and facial recognition becomes even more difficult when attempted in low-light conditions.

While some attempts have been made to accurately track facial expressions, it may be difficult to achieve satisfying high-fidelity visual effects on all types of human expressions. Accordingly, the present specification describes a multi-tasking facial tracking model with two separate machine learning branches. A first branch classifies a facial expression while a second branch predicts an AU intensity for a given input expression. By jointly training a machine learning system using both expression category classification and AU intensity regression tasks, the machine learning system may effectively model the relationship between the AUs and the appearance of corresponding facial regions in an input image and thus foster the learning of a more generalizable representation of AUs. Moreover, the present specification describes a system that provides the enhanced facial expression recognition with a single camera.

To predict the AU intensity, which drives the avatar's expression, the present machine learning system employs a deep learning (DL) model. DL models are effective in learning latent patterns in high-complexity signals (such as images) given a large corpus of training data. However, the lack of AU intensity ground truth poses a challenge in training a DL model for facial expression prediction. Accordingly, the present system includes a novel multi-branch pipeline for training the machine learning system with avatar expression images as an input and corresponding AU intensities as an output.

Specifically, the present specification describes a multi-tasking expression tracking system. The multi-tasking expression tracking system includes a feature extractor to extract a feature representation from an image of a user. The multi-tasking expression tracking system includes a classification branch including a classification neural network and the feature extractor. During training the classification branch is trained so that the classification neural network predicts expression classes for training images having different expressions. The multi-tasking expression tracking system also includes a regression branch including a regression neural network and the feature extractor. During training, the regression branch is trained to predict action unit (AU) intensities for the training images. During deployment, the regression branch is to predict an AU intensity from the image of the user.

The present specification also describes a method. According to the method, during a training phase, the expression tracking system obtains a dataset of training images of virtual avatars having different expressions. A classification neural network and a feature extractor are trained to predict expression classes for the training images based on extracted feature representations. A regression neural network and the feature extractor are trained to predict AU intensities for the training images based on the extracted feature representations. A predicted expression is generated based on predicted AU intensities.

The present specification also describes an extended reality system that includes an imaging system to capture an image of the user and a multi-tasking expression tracking system. The multi-tasking expression tracking system includes a feature extractor to extract a feature representation from the image of the user. The extended reality system includes a classification branch having a classification neural network and the feature extractor. During training, the classification branch is trained to, predict expression classes for the training images of virtual avatars having different expressions. The extended reality system also includes a regression branch having a regression neural network and the feature extractor. During training, the regression branch is trained to predict action unit (AU) intensities for the training images. During deployment, the regression branch is to predict an AU intensity for the image of the user.

The multi-tasking expression tracking system includes a display device to be worn on a head of the user to generate a user-based virtual avatar having an expression based on a predicted AU intensity for the image of the user.

In summary, the present systems and methods 1) track user's facial expressions using a single camera, 2) train via a multi-branched machine learning system to more effectively establish a model which predict AU intensities from an input facial expression; 3) are robust against different facial features, 4) generate expressions even in low-light conditions, and 5) reduce processing resources and increases bandwidth during facial recognition. However, it is contemplated that the devices disclosed herein may address other matters and deficiencies in a number of technical areas, for example.

As used in the present specification and in the appended claims, the term “engine” refers to a component that includes a processor and a memory device. The processor includes the circuitry to retrieve executable code from the memory and execute the executable code. As specific examples, the engine as described herein may include machine-readable storage medium, machine-readable storage medium and a processor, an application-specific integrated circuit (ASIC), a semiconductor-based microprocessor, and a field-programmable gate array (FPGA), and/or other hardware device.

As used in the present specification an in the appended claims, the term “memory” or “memory device” includes a non-transitory storage medium, which machine-readable storage medium may contain, or store machine-usable program code for use by or in connection with an instruction execution system, apparatus, or device. The memory may take many forms including volatile and non-volatile memory. For example, the memory may include Random-Access Memory (RAM), Read-Only Memory (ROM), optical memory disks, and magnetic disks, among others. The executable code may, when executed by the respective component, cause the component to implement the functionality described herein. The memory may include a single memory object or multiple memory objects.

Further, as used in the present specification and in the appended claims, the term XR environment refers to that environment presented by the XR system and may include an entirely digital environment, or an overlay of a digital environment on a physical scene viewed by the user. For example, the XR environment may be a VR environment which includes virtual imagery that is representative of physical spaces and/or objects. AR environments provide a real-world view of a physical environment with virtual imagery/objects overlaid thereon. MR environments re-create a real-world with virtual imagery/objects overlaid thereon to a user when the user does not have a direct view of the real world.

As used in the present specification and in the appended claims, the term “a number of” or similar language is meant to be understood broadly as any positive number including 1 to infinity.

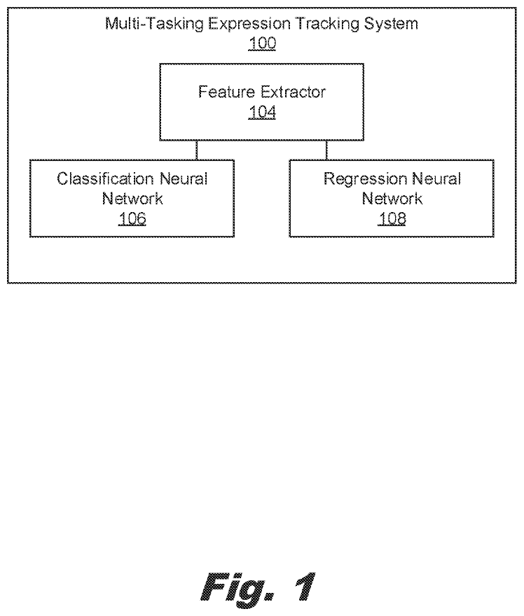

Turning now to the figures, FIG. 1 is a block diagram of a multi-tasking expression tracking system (100), according to an example of the principles described herein. As described above, an XR system generates an XR environment such as a virtual environment, a mixed environment, and/or an augmented environment. The multi-tasking expression tracking system (100) of the present specification facilitates the generation of avatars that accurately represent the emotional state of the users they represent. The multi-tasking expression tracking system (100) is a machine learning system where the ground truth, or the variable that is to be predicted based on an input, is the AU intensity. As such, a comparison of the predicted AU intensity to identified AU intensities from a dataset of training images determines the accuracy of the multi-tasking expression tracking system (100).

Accordingly, the multi-tasking expression tracking system (100) is trained to output an AU intensity from an input image of a user having a particular expression. A display device, or other such rendering engine, receives the output AU intensity from the multi-tasking expression tracking system (100) and manipulates an avatar associated with the user, such that the avatar has an expression that matches the expression of the user in the image.

As such, the multi-tasking expression tracking system (100) includes a feature extractor (104) to extract feature representations from an image, which feature representations serve as a basis to predict an AU intensity. The feature extractor (104) is trained based on a dataset of training images, which training images are of virtual avatars having different expressions. There may be hundreds, thousands, or millions of training images in the dataset. The training images in the dataset have an identified expression and are used to train the components of the multi-tasking expression tracking system (100). In other words, the multi-tasking expression tracking system (100) is to receive an image of a user with a particular expression and output an AU intensity which drives the avatar expression. Accordingly, the dataset contains training images of virtual avatars with identified expressions such that the multi-tasking expression tracking system (100) may learn how to interpret or identify AUs given a particular expression.

In an example, the dataset is a synthetic dataset of virtual avatars generated based on users, rather than images of the users themselves. Such a synthetic data-based modeling provides a diverse set of virtual avatars created from a reduced number of users. For example, in a test, 14 participants were asked to record and demonstrate 16 mouth expressions using a face tracking application which records video data and corresponding AU intensities. The participants were asked to demonstrate a variety of mouth expressions including closed mouth smile, open mouth smile, closed mouth frown, open mouth frown, cheek puff, pucker/pursed lips, anger teeth, mouth right, mouth left, mouth funnel, smile right, smile left, cheek squint right, cheek squint left, upper up right, upper up left, and cheek puff expressions. From these 16 expressions of 14 participants, 129 virtual avatars were generated with the different expressions. The expression images of these 129 virtual avatars formed the dataset for model training in this test. In other words, a synthetic dataset supports large-scale data generation to train a reliable and robust multi-task expression tracking system (100). The known variables of the dataset are the expression class and the AU intensity.

The training images are passed to a feature extractor (104) which extracts feature representations from the training images of the dataset (102). In general, a feature refers to an identifying or characterizing element of the object in the image. In the example of an image of a face of a user, the feature representations may be representations of the nose, eyes, mouth, cheeks, etc. Accordingly, feature extraction refers to a process wherein facial features, such as the nose, mouth, cheeks, etc. are extracted from an image. In other words, the feature extractor (104) parses a training image of a virtual avatar to identify the constituent parts of the virtual avatar's face.

In addition to identifying feature representations in a single image, the feature extractor (104) may track the features over a sequence of images in a video stream. In other words, the output of the feature extractor (104) may be a representation, e.g., a vector, identifying the different facial features of the virtual avatar and may also include movement vectors for the features over a sequence of frames.

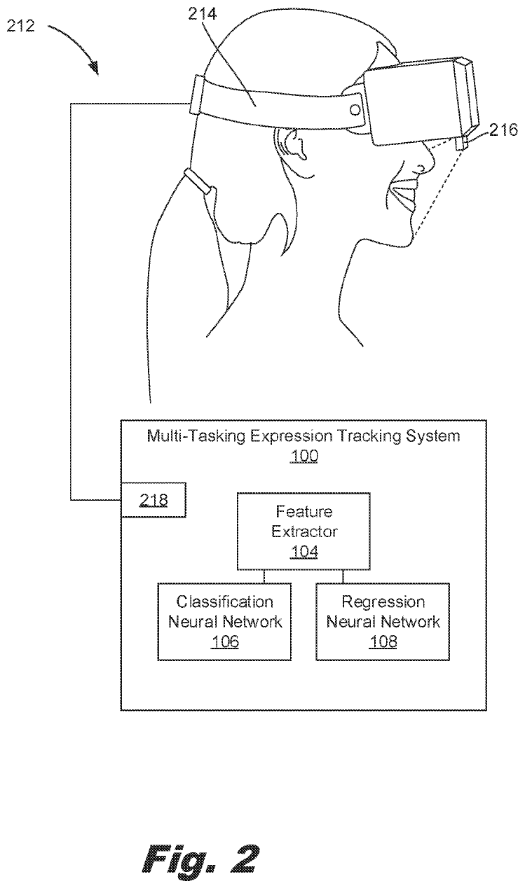

In one particular example, the feature extractor (104) may extract features pertaining to a particular region of the user's face. For example, as depicted in FIG. 2 below, a portion of the user's face may be covered by the HMD. Accordingly, a camera disposed below the HMD captures images of a lower portion of the user's face. As such, the feature extractor (104), and the multi-task expression tracking system (100) in general, may be trained to identify AU intensity based on lower facial expressions.

In an example, the feature extractor (104) may be a convolutional neural network (CNN). A CNN feature extractor (104) is a deep learning component which takes an input image, such as an image of a user, identifies certain features from the image, and differentiates one image from the other. In general, the CNN feature extractor (104) generates a feature representation from raw image input. The feature extractor (104) extracts useful information for recognizing the expression from a two-dimensional image through kernels and cascading layers that condense the information. An output of the feature extractor is a vector representation that includes information for recognizing the expression.

A CNN-based feature extractor (104) includes convolutional layers and pooling layers. Convolution layers are used to extract the features from images. Each convolution layer has a set of filters (kernels) and each filter (kernel) extracts a specific type of pattern in an image by traversing over the input image to produce the output feature maps. Different filters in a convolution layer may have different kernels with different structures that operate to identify different attributes. In an example, after each convolution operation, a Rectified Linear Unit (ReLU) transformation is applied to the feature map to introduce nonlinearity to the feature extractor (104). Each filter 1) may be connected to another filter, or convolution layer and 2) has an associated weight and threshold. If the output of any individual filter is above the specified threshold value, that filter is activated, sending data to the next layer of the network. Otherwise, no data is passed along to the next layer of the network.

As noted, the CNN may include multiple convolution layers. In general, as the depth of CNN increases, complexity of features identified by the convolution layers increases. For example, a first convolution layer may identify simple features, while a later convolution layer is able to identify complex features. As such, the CNN may be viewed as hierarchical as subsequent convolution layers may receive the identified features from a prior convolutional layer. In other words, with each layer, the CNN increases in its complexity, identifying greater portions of the image. Earlier layers focus on simple features, such as colors and edges. As the image data progresses through the layers of the CNN, it starts to recognize larger elements or shapes of the object until it finally identifies the intended object.

A pooling layer down samples the input data by summarizing each patch of the input data in one value to reduce the size of the input data. Pooling layers perform dimensionality reduction and reduce the number of parameters in the input. Similar to the convolutional layer, the pooling operation sweeps a filter across the entire input, but the difference is that this filter does not have any weights. Instead, the kernel applies an aggregation function to the values within the receptive field, populating the output array.

In a specific example, a convolution filter (kernel) traverses an entire input image using a convolution operation by a defined kernel size. In one particular example, a kernel size may be 3×3. A convolution operation may be performed between the input patch and the kernel. Output may be one value to fill in a cell of an output. A pooling layer divides the input data in a number of patches and summarizes each patch of the input data in one value, through averaging operation or max operation, for example. It reduces the size of its output, that is, the feature map.

The final layer of the CNN may classify the image based on the features extracted from previous convolutional layers. As such, the CNN identifies corners of facial features, edges of facial features, facial contours, etc. to identify the particular elements of a face. The output of the feature extractor (104) is a vector of information relating to the different facial features and how those facial features change over time through a sequence of images.

The output of the feature extractor (104) is fed to multiple neural networks, thus facilitating the “multi-task” machine learning. First, during training the classification branch, which includes the feature extractor (104) and a classification neural network (106) are trained to predict expression classes for the training images. Specifically, the extracted feature representations are passed to a classification neural network (106) which is to predict expression classes for images based on extracted feature representations. That is, the classification neural network (106) classifies the identified facial feature and facial feature movements as a particular expression class, such as those defined in the FACS database.

In other words, the input to the classification neural network (106) is vector representations of the facial features and their movement over time. An output of the classification neural network (106) may be a classification of the facial expression. There are a variety of classifications for a detected facial expression. Examples include closed mouth smile, open mouth smile, closed mouth frown, open mouth frown, cheek puff, pucker/pursed lips, anger teeth, mouth right, mouth left, mouth funnel, smile right, smile left, cheek squint right, cheek squint left, upper up right, upper up left, and cheek puff expressions. Examples of other facial expressions include those identified in the FACS database.

As such, the output of the feature extractor (104) is a latent image, with information of the facial expression depicted therein, i.e., the identified features and how the identified features are moving. The classification neural network (106) determines a classification for the movements identified by the feature representations. In an example, the classification neural network (106) may be a fully connected neural network which includes multiple fully connected (FC) layers followed by an output layer. After the input, an extracted feature representation vector, is passed through multiple FC layers, the converted representation is passed to the output layer such that a final expression classification may be output.

Note that during training, the classification neural network (106) is used to identify expression classifications. However, during deployment, operation of the classification neural network (106) is suspended. This is because the output of the classification neural network (106) is an expression classification, but the desired output of the multi-tasking expression tracking system (100) is an AU intensity, which AU intensity drives avatar expression generation.

During training however, the output of the classification neural network (106) may be leveraged to increase the shared feature extraction accuracy through back-propagation. In general, a neural network, such as the feature extractor (104), is trained using the error between the temporary prediction result and the ground truth in each iteration of an iterative training process. In this way, the hyper-parameters of the feature extractor (104) as well as the classification neural network (106) are trained to recognize the target variables, in our case, the category of the expression.

Put another way, during iterative training cycles, an output has an associated error. Neuron weights and biases can be updated so that the error is reduced. Accordingly, the determined classification may be fed back into the feature extractor (104) as a measure of accuracy and correctness of feature extraction. In other words, the predicted expression classifications may be used by an optimization operation to adjust the weights and biases of the different kernels.

As such, the classification neural network (106) may aid the feature extractor (104) in more efficiently and accurately determining feature representations from the training images. Because the target AU vector is 23 dimensional, learning a good feature representation that maps each AU element to the corresponding region in the input image is inherently difficult. The high entanglement within the AUs brings increased difficulty to learn an effective feature extractor from a single regression branch. The dedicated classification neural network (106) assists with the training of the feature extractor.

The second branch of the multi-tasking expression tracking system (100) is a regression branch that includes the feature extractor (104) and a regression neural network (108). This regression branch is trained to predict the AU intensities based on an input expression. Accordingly, the output of the feature extractor (104) is passed to a regression neural network (108). The regression neural network (108) has a similar mechanism as the classification neural network (106), except that the output of the regression neural network (108) is not the probability of each class, but the predicted value of the interested variable. Specifically, as described above, each AU has an intensity, referring to a degree of movement of the muscle or groups of muscles. This AU intensity correlates to a particular facial expression. Accordingly, the regression neural network (108) may receive as input an image with a particular expression. The regression neural network (108) identifies an AU intensity associated with the expression. A display device of an XR system may then generate an avatar with the particular expression given an input of the predicted AU intensity from the regression neural network (108).

In other words, the input to the regression neural network (108) is vector representations of the facial features and their movement over time. An output of the regression neural network (108) may be an intensity of the detected AU. In an example, the AU intensity may be a numeric value between 0 and 100 where 100 represents a maximum facial deflection and 0 represents no facial deflection. In another example, the AU intensity may be a normalized value between 0 and 1.

As such, the output of the feature extractor (104) is a latent image, with information of the facial expression depicted therein, i.e., the identified features and how the identified features are moving. This is received at the regression neural network (108) and operated on to determine an intensity of the AU associated with the extracted feature representations. In an example, the regression neural network (108) may be a fully connected neural network which includes multiple fully connected (FC) layers followed by an output layer. After the input, an extracted feature representation vector, is passed through multiple FC layers, the converted representation is passed to the output layer such that a final AU intensity may be output.

The training of the classification branch and the regression branch occur non-simultaneously. When training the classification branch, the feature extractor (104) and the classification neural network (106) are trained as a whole entity. When training the regression branch, the feature extractor (104) and the regression neural network (108) are trained as a whole entity. As such, the feature extractor (104) is trained during both the regression and classification tasks. As there are two tasks where the feature extractor (104) is trained and adjusted, the feature extractor (104) becomes more accurate in recognizing an expression from feature representations of an input image.

FIG. 2 is a diagram of an XR system (212) which includes the multi-tasking expression tracking system (100), according to an example of the principles described herein. The XR system (212) includes a display device (214) that is worn by a user to 1) generate visual, auditory, and other sensory environments, 2) detect user input, and 3) manipulate the XR environment based on the user input. In an example, the display device (214) covers the eyes of the user and presents the visual information in an enclosed environment formed by the display device (214) housing and the user's face.

The display device (214) presents the user-based virtual avatar having an expression based on a predicted AU intensity extracted from an image of the user. The display device (214) may implement a variety of display modalities including a projection system and a screen, a liquid crystal display (LCD), or a light-emitting diode (LED) display, among others. While reference is made to particular display modalities, the display device (214) may implement any variety of display modalities to present the XR environment, and specifically the virtual avatar, to the user. Moreover, while FIG. 2 depicts a particular configuration of the XR system (212), any type of XR system (212) may be used in accordance with the principles described herein. In this example, the XR system (212) is communicatively coupled to a processor and computer readable program code executable by the processor which causes a view of the XR environment to be displayed in the display device (214).

The XR system (210) also includes an imaging system (216) to capture an image of the user. In an example, the imaging system (216) captures an image of a lower portion of a user's face. That is, as depicted in FIG. 2, a portion of the user's face may be covered by the display device (214). However, the portion of the user's face below the display device (214) remains uncovered and as such is captured and used to identify the user expression. During deployment, these captured images of the lower portion of the user's face are processed by the multi-tasking expression tracking system (100) to generate an expression on the user-based virtual avatar that matches the captured expression of the user.

In another example, the imaging system (216) may include additional cameras, such as cameras within the housing directed at the user's eyes. Similar to how the multi-tasking expression tracking system (100) may be trained to identify AU intensities from expressions/muscle movements of a lower portion of the face, the multi-tasking expression system (100) may be further trained to identify AU intensities from expressions at an upper portion of the face, i.e., the eyes. Determining AU intensities at lower and upper regions of the user's face may allow for an even more accurate replication of a user's expression on a corresponding virtual avatar.

The imaging system (216) may have a variety of forms. For example, the imaging system (216) may include a single infrared camera(s) directed at a lower portion of the face of the user. In the example of expression replication based on upper face AU intensities, the cameras directed at the user's eyes may similarly be infrared cameras. An infrared imaging system (216) can track user expressions in varied illumination conditions, even in an extremely dark environment. Accordingly, the multi-tasking expression tracking system (100) can generate user-based expressions on a virtual avatar in a variety of lighting conditions, including low light conditions.

In this example, the imaging system (216) may be integrated into a housing of the display device (214). That is, rather than being a separate component, the imaging system (216) may be attached to the display device (214) and directed towards the lower face of the user. In some examples, the imaging system (216) may also extend below the housing of the display device (214) as so doing provides a capture region of the lower portion of the user's face.

During deployment, the captured images are processed by the multi-tasking expression tracking system (100). Accordingly, the multi-tasking expression tracking system (100) includes an input (218) to receive an image of the user from the imaging system (216). The received image is to trigger manipulation of the user-based virtual avatar. That is, during deployment, the image of the user is passed to the feature extractor (104) which extracts feature representations from the image of the user. As such, during training, the feature extractor (104) extracts feature representations from the training images in the dataset while during deployment the feature extractor (104) extracts feature representations from the image of the user.

During deployment, the classification neural network (106) is inactive while the regression neural network (108) remains active and receives the extracted feature representations from the feature extractor (104). The classification neural network (106) is inactive as its output, i.e., an expression classification, is not used by the generation engine (110) to generate a facial expression for the avatar. As such, during training, the classification neural network (106) predicts expression classes based on extracted features from the images of the dataset. During deployment, the classification neural network (106) is inactive.

Because the AU intensity output by the regression neural network (108) is relied on by the display device (214), the regression neural network (108) remains active during deployment. Specifically, the regression neural network (108), based on the training described earlier, predicts an AU intensity for the image of the user based on the extracted feature representations for the image of the user. That is, during training, the regression neural network (108) predicts AU intensities for training images in the dataset (102). During deployment, the regression neural network (108) predicts AU intensities for the captured image of the user.

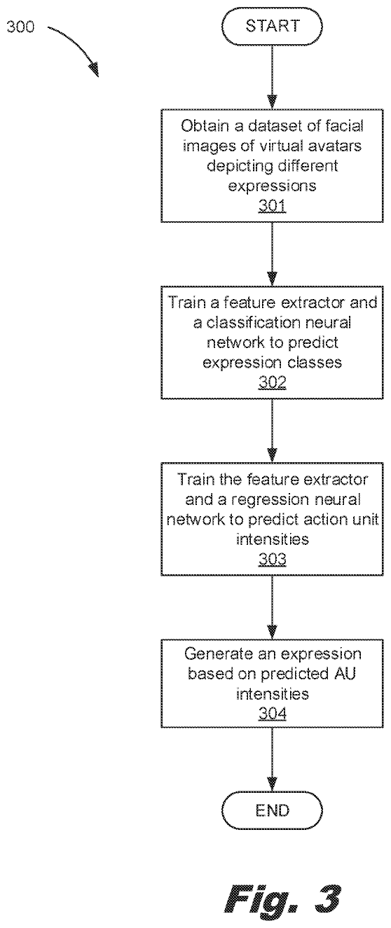

FIG. 3 is a flowchart of a method (300) for tracking facial expressions via a multi-tasking expression tracking system (100), according to an example of the principles described herein. The method (300) depicted in FIG. 3 depicts operations that may occur during training, that is before the multi-tasking expression tracking system (100) receives a user image to drive avatar expression generation.

According to the method (300), the multi-staking expression tracking system (100) obtains (block 301) a dataset of training images of virtual avatars depicting different expressions. That is, the training images may be of virtual avatars having different facial characteristics, facial shapes, or other different features. Within the training images, there may be multiple images of each avatar, the different images representing the avatar with a different facial expression. As described above, the known variables from these virtual avatars include 1) a facial expression and 2) an AU intensity. Accordingly, the multi-tracking expression tracking system (100) may receive the training images, classify the expressions depicted therein, and predict AU intensities for each training image. The resulting outputs may be compared to the ground truths, i.e., the known variables. The weights and biases of the neurons of the neural networks may be adjusted until the loss converges towards zero when the resulting outputs are compared against the ground truths.

As described above, the images may be synthetic images which are virtual avatars generated based on images of users. Synthetic data allows for a larger group of images than would otherwise be possible from actual users.

As described above, the classification branch, which includes the feature extractor (104) and the classification neural network (106) are trained (block 302) to predict expression classes for the training images. Specifically, the feature extractor (104) extracts feature representations from the facial images, which feature representations are vector representations of the different anatomical features of a face and/or vector representations of the movement of the anatomical features of the face. One example of a feature may be a left lip corner and/or an indication that over a sequence of frames, the left lip corner moves in an upward direction. The feature representations are passed to a classification neural network (106) to train the classification neural network (106) to predict expression classes for the training images.

In a similar fashion, the regression branch, which includes the feature extractor (104) and the regression neural network (108) are trained (block 303) to predict AU intensities for the training images. As such, the feature representations are also passed to a regression neural network (108) to train the regression neural network (108) to predict AU intensities based on extracted feature representations. The passing of these feature representations and subsequent processing represents a training of these neural networks such that when an image of a user is captured during deployment, the feature extractor (104) and regression neural network (108) may alter a user-based virtual avatar with the expression that the neural networks identify on the input image of the user.

Note that the classification branch and the regression branch are separately trained. For example, the classification neural network (106) is trained while the regression neural network (108) is inactive. Following training of the classification neural network (106), the feature representations are passed to the regression neural network (108) for training while the classification neural network (106) is inactive. Training the branches separately results in a quicker convergence towards an acceptable loss. That is, with each iteration of training, the neural network loss is reduced, this is referred to as convergence. The rate of convergence increases, that is it approaches zero more quickly, when each neural network is trained independently. Following training of both the branches, a predicted expression is generated (block 305) based on the predicted AU intensities.

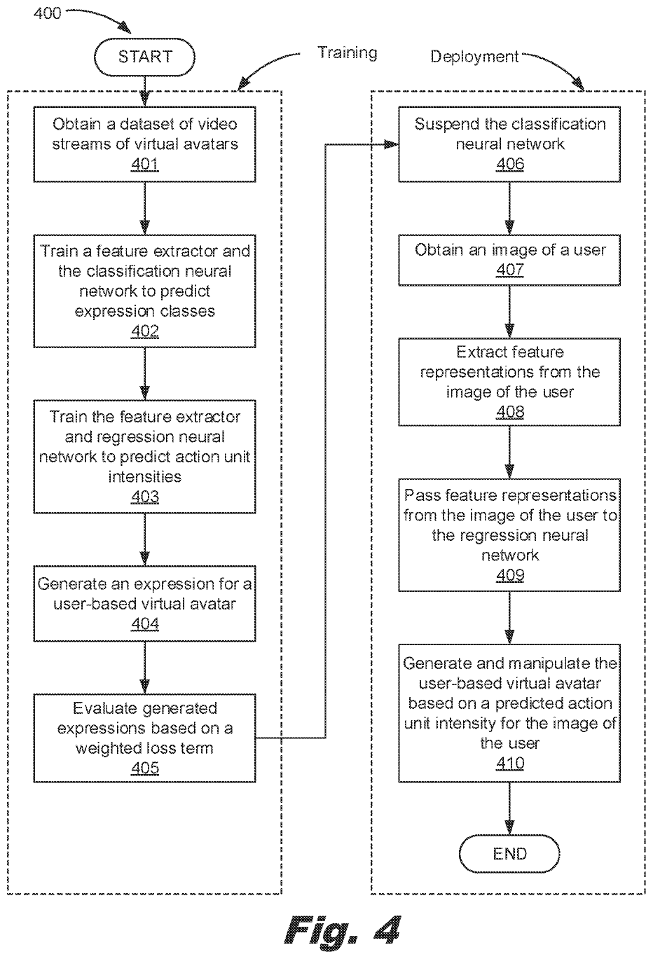

FIG. 4 is a flowchart of a method (400) for tracking facial expressions via a multi-tasking expression tracking system, according to an example of the principles described herein. As compared to FIG. 3, FIG. 4 depicts the operation of the multi-tasking expression tracking system (100) during training and during deployment.

As described above, during training, the multi-tasking expression tracking system obtains (block 401) a dataset of training images, which may be video streams, of virtual avatars. This may be done as depicted in FIG. 3. In some examples, before being used to train the neural networks, the video streams may be trimmed. Specifically, the multi-tasking expression tracking system may trim a beginning and ending of each video stream. That is, at the beginning and ending of a video stream, an avatar may be in transition from a neutral face to an expressional face. These transitional or neutral faces may negatively impact the training and/or result in a neural network with an inaccurate or less accurate estimate. By removing the start and end segments of the video stream, these transition faces are removed while the middle part of a video stream, which includes the expressional face, is retained and used to train the neural networks. As described above in connection with FIG. 3, the feature extractor (104) and the classification neural network (106) are trained (block 402) to predict expression classes. As described above, the classification neural network (106) is activated during training to backpropagate the calculated expression classes to increase the convergence rate of the feature extractor (104). Accordingly, during training, the predicted expression classes are passed to the feature extractor (104) to refine the feature representation extraction. Also as described above in connection with FIG. 3, the feature extractor (104) and the regression neural network (108) are trained (block 403) to predict AU intensities for the training images.

As described above in connection with FIG. 3, a predicted expression for the virtual avatar is generated (block 404). In some examples, the accuracy and correctness of the multi-tasking expression tracking system may be evaluated. That is, the “loss” of a neural network refers to the difference between a predicted result and the ground truth. In this example, as there are two branches, i.e., the classification neural network (106) branch and the regression neural network (108) branch, there are two loss terms. Accordingly, evaluating (block 405) the multi-tasking expression tracking system includes weighting a loss term for the classification neural network (106) with a loss term for the regression neural network (108) to evaluate the predicted expressions. The loss term for the regression neural network (108) may be a Mean Average Error (MAE) loss and the loss term for the classification neural network (106) may be a cross-entropy loss. A weighting, average, or other combination of these loss terms indicates a loss for the entire multi-tasking expression tracking system.

During deployment, the classification neural network (106) is suspended (block 406). This is done because the output of the classification neural network (106) is not implemented to generate an avatar expression, but is rather used to refine and enhance the training of the feature extractor (104). Still during deployment, an image of a user is obtained (block 407), which image is to trigger manipulation of a user-based virtual avatar. Specifically, the expression of the user in the image is to be the expression that is superimposed on the user-based virtual avatar.

As described above, the feature extractor (104) extracts (block 408) feature representations from the image of the user, and these user image-extracted feature representations are passed (block 409) to the regression neural network (108). The regression neural network (108), which has been trained to identify AU intensities for extracted feature representations, outputs an AU intensity associated with the facial expression of the user in the images such that the display device (214) generates (block 410) and manipulates a user-based virtual avatar based on the predicted AU intensity. That is, the display device (214) may access information which is used to generate an avatar. This information is updated or altered such that the facial expression of the virtual avatar matches the facial expression of the user in the image or video stream.

That is, the regression neural network (108) is trained to identify AU intensities based on an input facial expression. During deployment, the input facial expression may be that of a user of the XR system (212). In this example, the regression neural network (108) receives the image of the user having some particular facial expression and outputs a predicted AU intensity to the display device (214). The display device (214) then receives the AU intensity and modifies a template avatar, whether individualized to the user or not, to generate an expression that is based on the facial expression of the user in the image.

For example, were a user to puff out their cheeks, the feature extractor (104) and regression neural network (108) would detect the AU intensity and the display device (214) would modify the user-based virtual avatar to have puffed-out cheeks. As such, the multi-tasking expression tracking system (100) tracks facial expressions to re-enact or simulate the user expression on a virtual avatar. The predicted AU intensity is used to generate and manipulate the virtual avatar. Through the joint training of the classification branch and regression branch, the training process can receive a higher accuracy at the end and become more stable than using a single regression network. The model can achieve better generalizability with higher accuracy when being deployed on the new users. As such, the method (400) provides for a multi-branch training of a machine learning expression tracking system, and then in real-time updates an expression of an avatar in an XR environment to match the expression of the user in the image or video stream.

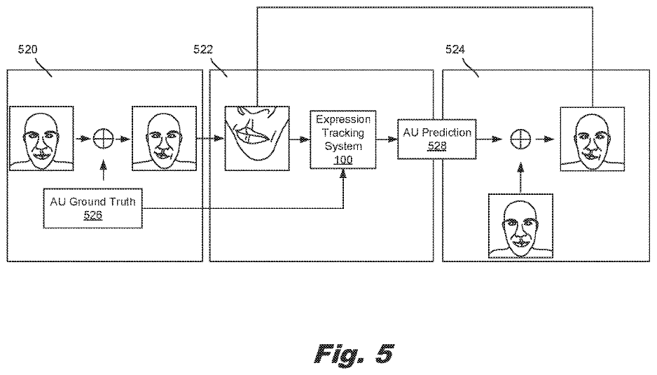

FIG. 5 depicts the training of the multi-tasking expression tracking system (100), according to an example of the principles described herein. FIG. 5 depicts the three stages of operation of the multi-tasking expression tracking system (100). Specifically, FIG. 5 depicts a data generation stage (520), a training stage (522) and an avatar generation stage (524).

During the data generation stage (520), an input dataset for the multi-tasking expression tracking system (100) is established. This is accomplished by obtaining an AU ground truth (526). As described above, the AU ground truth (526) is the variable ultimately predicted by the multi-tasking expression tracking system (100). In an example, the AU ground truth (526) may be established by processing a number of user images making known facial expressions with known AU intensities. During data generation, these user images are synthesized and amplified to create a dataset of training images of avatars having different expressions.

These input images are used to train the multi-tasking expression tracking system (100) during the training stage (522) along with the AU ground truth (526). As depicted in FIG. 5, it may be that just a cropped portion of the images in the dataset (102) are to be used to train the multi-tasking expression tracking system (100). In another example, the images are not cropped, but are images of a full face of the user. The AU ground truth (526) along with the training images are passed to the multi-tasking expression tracking system (100) to train the multi-tasking expression tracking system (100) to output an AU prediction (528). This may be done as described above. That is, once the input training image is fed into the multi-tasking expression tracking system (100) as input, the feature extractor (104) extracts the feature representation of the input image and the regression neural network (108) predicts the AU intensity. The other branch, the classification neural network (106) uses the same feature extractor (104) as the regression neural network (108). The classification neural network (106) predicts the expression class.

With the multi-tasking expression tracking system (100) trained in AU prediction, the multi-tasking expression tracking system (100) generates an avatar in the avatar generation stage (524). In this stage, a base expressionless avatar is combined with an input image. The multi-tasking expression tracking system (100) receives such and applies the AU prediction (528) such that a modified avatar is generated from the template avatar, which modified avatar has the expression of the input image.

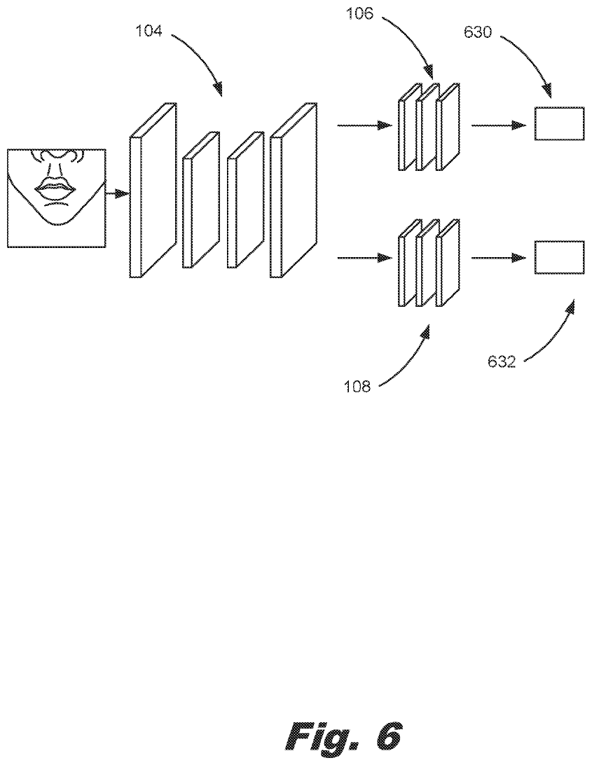

FIG. 6 depicts a training stage (522) of the multi-tasking expression tracking system (100), according to an example of the principles described herein. Specifically, FIG. 6 depicts the multi-branching nature of the training stage (522) where a training image of a virtual avatar with known expression and known AU intensity is fed to the multi-tasking expression tracking system (100). More specifically, the training image is passed to the feature extractor (104) which may be a CNN with multiple layers. As described above, the output of the feature extractor (104) are the multiple vector-based feature representations of the features of the image. The feature representations are passed to a classification neural network (106), which may be a fully connected neural network. The classification neural network (106) processes the feature representations as described above to output an expression class (630) identified for each image. As described above, this expression class (630) may be fed back to the feature extractor (104) to reduce the number of iterations in the training stage (520) for the multi-tasking expression tracking system (100) to identify an AU prediction (528).

At a different point in time, the feature representation is passed to a regression neural network (108) which processes the feature representation as described above to output an AU intensity (632). This AU intensity (632) is the output of the multi-tasking expression tracking system (100) that will drive generation of the user-based avatar expression.

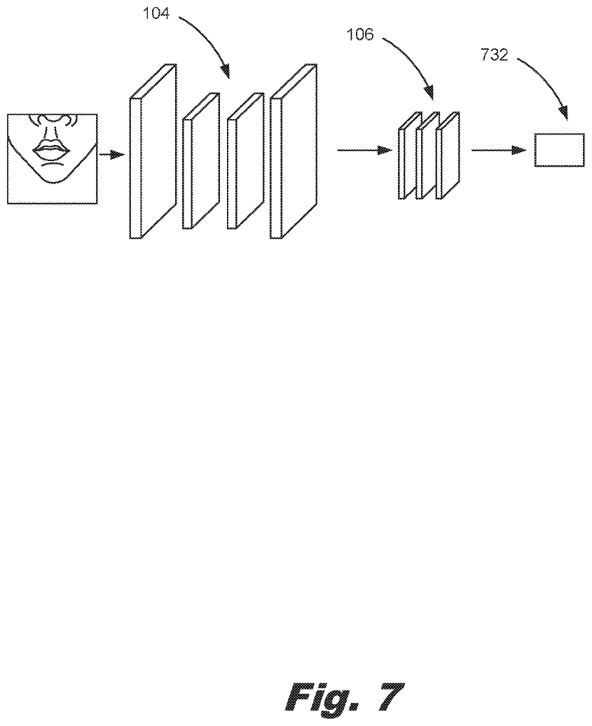

As described above, operation of the multi-tasking expression tracking system (100) is different during deployment. FIG. 7 depicts a deployment stage of the multi-tasking expression tracking system (100), according to an example of the principles described herein.

As described above, once the multi-tasking expression tracking system (100) has been trained, the classification neural network (106) operation is suspended. In this example, an input image, which may be a video stream from an XR system (212) is fed into the feature extractor (104). In some examples, the input image may be pre-processed to facilitate the operations of the multi-tasking expression tracking system (100). For example, the input image may be pooled and/or processed to increase the contrast of the input image. The feature representation is extracted and fed to the regression neural network (108) which outputs a predicted AU intensity (732) for the user input image. As descried above, this AU intensity (732), which may represent the degree of multiple AUs is applied to a template avatar to generate an avatar with a tracked expression of the user.

In summary, the present systems and methods 1) track user's facial expressions using a single camera, 2) train via a multi-branched machine learning system to more effectively establish a model which predict AU intensities from an input facial expression; 3) are robust against different facial features, 4) generate expressions even in low-light conditions, and 5) reduce processing resources and increases bandwidth during facial recognition. However, it is contemplated that the devices disclosed herein may address other matters and deficiencies in a number of technical areas, for example.

What is claimed is:

1. A multi-tasking expression tracking system, comprising:
a feature extractor to extract a feature representation from an image of a user;
a classification branch, comprising a classification neural network and the feature extractor to, during training, predict expression classes for training images having different expressions;
a regression branch, comprising a regression neural network and the feature extractor to:
during training, predict action unit (AU) intensities for the training images; and
during deployment, predict an AU intensity for the image of the user.

2. The multi-tasking expression tracking system of claim 1, wherein the training images are of virtual avatars.

3. The multi-tasking expression tracking system of claim 2, wherein the training images are facial images of the virtual avatars.

4. The multi-tasking expression tracking system of claim 1, further comprising:
an input to receive the image of the user; and
wherein during deployment:
the image of the user is passed to the feature extractor to extract the feature representation from the image of the user; and
the classification neural network is to be inactive while the regression neural network is to be active.

5. The multi-tasking expression tracking system of claim 1, wherein the feature extractor is a convolutional neural network.

6. The multi-tasking expression tracking system of claim 1, wherein:
the classification neural network is a fully connected neural network; and
the regression neural network is a fully connected neural network.

7. The multi-tasking expression tracking system of claim 1, wherein the classification neural network and the regression neural network are separately trained.

8. A method, comprising:
during training:
obtaining a dataset of training images of virtual avatars having different expressions;
training a classification neural network and a feature extractor to predict expression classes for the training images based on extracted feature representations;
training a regression neural network and the feature extractor to predict action unit (AU) intensities for the training images based on extracted feature representations; and
generating a predicted expression for an avatar based on predicted AU intensities.

9. The method of claim 8, further comprising, during training, passing predicted expression classes to the feature extractor to refine feature representation extraction.

10. The method of claim 8, further comprising:
during deployment:
suspending the classification neural network;
obtaining an image of a user, which image of the user is to trigger manipulation of a user-based virtual avatar;
extracting, with the feature extractor, a feature representation from the image of the user;
passing the feature representation of the image of the user to the regression neural network to predict an AU intensity for the image of the user; and
generating and manipulating the user-based virtual avatar based on the predicted AU intensity.

11. The method of claim 8:
wherein the dataset of training images comprises video streams of the virtual avatars; and
the method further comprises trimming a beginning and ending of each video stream.

12. The method of claim 8, further comprising weighting a loss term for the classification neural network with a loss term for the regression neural network to evaluate a generated expression.

13. An extended reality system comprising:
an imaging system to capture an image of a user;
a multi-tasking expression tracking system, comprising:
a feature extractor to extract a feature representation from the image of the user;
a classification branch comprising a classification neural network and the feature extractor to, during training, predict expression classes for training images of virtual avatars having different expressions;
a regression branch comprising a regression neural network and the feature extractor to:
during training, predict action unit (AU) intensities for the training images; and
during deployment, predict an AU intensity for the image of the user; and
a display device to be worn on a head of the user to generate a user-based avatar having an expression based on a predicted AU intensity for the image of the user.

14. The extended reality system of claim 13, wherein the imaging system comprises a single infrared camera directed at a mouth of the user.

15. The extended reality system of claim 14, wherein the imaging system comprises multiple infrared cameras directed at eyes of the user.
